(19) United States
(12) Patent Application Publication
(10) Pub. No.: US 2005/0202199 A1
(43) Pub. Date: Sep. 15, 2005

(54) Prefabricated mosaic modules

(76) Inventor: Carmine Di Costanzo, Siano (IT)

Correspondence Address: Mark D. Wieczorek, Ph.D., Esq.;C/o Mayer Fortkort & Williams, 251 North Avenue West, Westfield, NJ, 07090, US

(21) Appl. No.: 10/798,229

(22) Filed: Mar. 11, 2004

(51) Int. Cl. B32B 3/10

(52) U.S. Cl. 428/44

(57) ABSTRACT

Prefabricated modules for the creation of mosaics consisting of a number of tesserae 1 attached by a layer of glue 4 to a flat support structure consisting of a rigid expanded polystyrene core 2 covered by a layer 3 of reinforced fiber glass mortar on both faces. The above solution also offers the significant advantage of cost reduction and faster application times when applying the mosaic to flat surfaces. Another notable advantage is the support itself that, thanks to its stiffness, means that the tesserae are firmly attached so that the risk of detachment and misalignment of the individual tesserae during transport, handling and application of the modules are significantly reduced.

### FIELD OF THE INVENTION

The field relates to prefabricated mosaic modules for cost reduction for ease of mosaic application to flat surfaces.

### BACKGROUND OF THE INVENTION

In mosaic production, it is common practice for factories to pre-assemble panels of tesserae glued to a flexible support, the flexible support being essentially netting that serves the dual purpose of holding the tesserae together and acting as the medium for attaching to the surface where the panel is to be applied, using mortar or glue followed by putty application.

The positioning of the tesserae on the netting supports is difficult to control due to the deformable nature of the netting. In fact, it is difficult to guarantee the stability of the individual tesserae on the support, which are often at risk of detaching, especially during transport and handling.

However, the greatest difficulty arises during the applying of the mosaic to the wall. In fact, the mosaic application operation requires careful preparation of the wall in question, which involves a considerable amount of time and therefore high costs for skilled labor. Moreover, correct mosaic tesserae application can often only be ensured by tapping the tesserae all over while the underlying surface is still damp, making it difficult to align the tesserae and with the risk of an irregular aesthetic effect, making mosaic application work very slow, even if carried out by experts.

### SUMMARY OF THE INVENTION

One aspect of this invention is the development of flat prefabricated ornamental mosaic modules that provide good value for their cost, strength, and faster, more practical mosaic application to surfaces, without altering the aesthetic aspect typical of the mosaic.

Another aspect of this invention, in accordance with the above, is to develop prefabricated mosaic modules that can substantially be totally adhered to the underlying cement or putty surfaces. The substantially perfect dimensional uniformity of these modules makes them easy to align during application, which can even be carried out easily and accurately by non-expert personnel, so as to obtain a substantially perfect end result.

Another aspect of this invention, in accordance with the above, is to develop flat prefabricated mosaic modules for use on floors or walls, with well attached and aligned tesserae, which will not easily become detached from the support during transport, storage, handling or application.

Another aspect of this invention, in accordance with the above, is to develop prefabricated mosaic modules, such as those that are square or rectangular in form, in the sizes preferred and determined by practical experience.

These and other features and advantages will become evident in the following description and in the enclosed drawings, provided for illustrative and non-binding purposes only, in which:

### BRIEF DESCRIPTION OF THE DRAWINGS

FIG. 1 shows a schematic perspective view of a square prefabricated mosaic module.

FIG. 2 shows a side schematic view of the constitutional elements of an embodiment of a prefabricated mosaic module in accordance with this invention.

### DETAILED DESCRIPTION

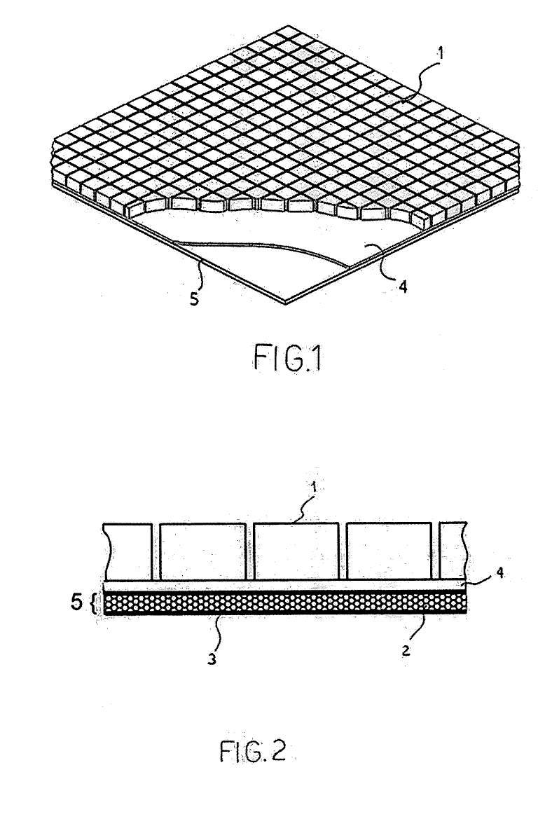

Referring to FIG. 1, a module is shown having a flat support structure 5 to which a number of tesserae 1 are attached, forming a mosaic. The flat support structure 5 includes a rigid expanded polystyrene core 2 covered by a layer 3 of reinforced fiberglass mortar on both faces. The tesserae 1 are attached to this support by a layer of glue 4.

The module, as described above, is available in the geometric shapes in the plan and any dimensions. During practical experience in developing mosaics, two preferred geometric shapes with optimal dimensions were identified. The former has with a square shape measuring 295.5×295.5 mm. The latter has a rectangular shape measuring 295.5×939 mm. The overall thickness of the module, in the two cases in question, amounts to 16 mm, with the support structure measuring 4 mm.

The above solution also offers the significant advantages of cost reduction and faster application times when applying the mosaic to flat surfaces. Another notable advantage is the support itself that, due to its stiffness, means that the tesserae are firmly attached so that the risk of detachment and misalignment of the individual tesserae during transport, handling and application of the modules are significantly reduced.

1.) a prefabricated module for the creation of mosaics, comprising:
a. A plurality of terrerae attached by a layer of glue to a support structure, the support structure including a rigid expanded polystyrene core having two opposing surfaces, the core at least partially covered by a layer of reinforced fiberglass mortar on each of said surfaces.

2.) The module of claim 1, wherein the flat support is about 4 mm thick.

3.) The module of claim 1, wherein the module has a square geometric shape measuring about 295.5×295.5 mm and is about 16 mm thick.

4.) The module of claim 1 wherein the module has a rectangular geometric shape measuring about 295.5×939 mm and is about 16 mm thick.

5.) The module of claim 1 wherein the rigid support is structured and configured such that the rigid support has a uniform size, alignment and tesserae fixture whereby it is possible to attach a plurality of prefabricated modules to an underlying cement or putty surface without the need to tap the tesserae all substantially all of their extent while the underlying support is still damp.
